(19) United States
(12) Patent Application Publication
(10) Pub. No.: US 2003/0231399 A1
(43) Pub. Date: Dec. 18, 2003

(54) Illuminated portable shield for portable computers

(76) Inventor: Julio Leitao, New York, NY (US)

Correspondence Address: ALFRED M. WALKER, 225 OLD COUNTRY ROAD, MELVILLE, NY, 11747-2712, US

(21) Appl. No.: 10/325,098

(22) Filed: Dec. 20, 2002

Related U.S. Application Data
(60) Provisional application No. 60/389,379, filed on Jun. 18, 2002.

(51) Int. Cl. G02B 27/00

(52) U.S. Cl. 359/614

(57) ABSTRACT

A collapsible shade device for a portable laptop computer includes a top panel, a back panel hinged to a rear edge of the top panel, wherein the back panel has right and left foldable snap panels. The side panels are hinged to side edges of the top panel so that in the deployed position, these side panels are at right angles to the top panel. The foldable snap panels fold over the outside of the side panels to form a partial enclosure with the back panel provided at a right angle to the top panel. Brackets are hinged along edges of the side panels adjacent to the back panel for engaging the sides of a screen panel of the portable laptop computer. An optional light for the keyboard can be provided.

### FIELD OF THE INVENTION

The present invention relates to shades for portable laptop computers.

### BACKGROUND OF THE INVENTION

Portable computers are used in a wide variety of venues. When used outdoors, such as in a backyard, by a pool, or in a park, the LCD screen is prone to “wash-out” by ambient light. In addition, glare from sunlight is annoying as are secondary reflections. Infrared radiation from solar gain also causes damaging heat build-up in the electronic circuits and battery. When working in public places such as a beach or park or in conveyances such as trains, planes, or busses, the added factors of maintaining privacy and confidentiality of screen contents are also concerns. Sometimes it is difficult to see the keyboard when attempting to work in a darkened area (e.g., on a train or airplane) without disturbing others.

### OBJECTS OF THE INVENTION

It is therefore an object of the present invention to provide a shade for a portable laptop computer.

It is also an object of the present invention to provide a lighted shade for a portable laptop computer for illuminating the keyboard under dark lighting conditions.

Other objects will become apparent from the following description of the present invention.

### SUMMARY OF THE INVENTION

In keeping with these objects and others which may become apparent, the present invention is a portable shade for portable laptop computers, which in a preferred embodiment includes a small, unobtrusive lamp for illuminating the keyboard under darkened lighting conditions.

The shade shield of the present invention enhances the use of portable laptop computers by enabling their use in difficult lighting conditions, such as darkened areas or in excessive lighting areas with glare, where the shade shield hides the screen from the excess glare. The addition of a small compact lamp enables the keyboard to be used in darkened lighting conditions.

The use of the shade shield provides the portable laptop computer with versatility in where in can be used, such as in a train or on a beach.

The important portability function of the laptop computer is maintained with the shade shield feature. The synergistic combination of the shade shield with a lamp to illuminate the keyboard provides beneficial effects that are not possible with any other type of shade shield for a laptop computer.

In a preferred embodiment, the illuminated portable shield of this invention prevents screen “wash-out”, glare and reflections, keeps the portable computer cooler in direct sunlight, and provides privacy and confidentiality in crowded environments. In addition, a source of soft directed illumination is included to make the keyboard visible in a darkened environment.

This lightweight shield folds into a flat compact size when not in use and fits inside a carrying case with the user's laptop or notebook computer. Similar shields can also be supplied to fit DVD and Global Positioning System screens. A particular shield is designed and sized to fit a particular brand and model of portable device. Unlike similar products, the shield of this invention requires absolutely no modification to the user's computer (not even the attachment of VELCRO® strips).

The shield of this invention has panels which fold into an open position whereby two small flaps attached to a back panel are folded to snap into two side panels to lock into the open position. Folding channel members attached to the side panels are then slid over the left and right sides of the computer LCD display panel securing the shield in place such that the top and side panels provide their essential function while permitting full angle adjustment of the screen.

To fold the shield, it is first slid off the computer display panel. Then the two small flaps are unsnapped from the side panels. The various panels are then folded on each other and the flat configuration is secured by snapping the two male snaps of the two small flaps into two auxiliary female snaps attached to the top surface of the large top panel. Although hook and loop fasteners (e.g., VELCRO®) can be used instead of the snaps, the snaps provide more rigidity and shape precision to the open configuration.

The various panels and the hinges, which attach all parts together, can be constructed in a manner similar to binders and portfolios (and of similar materials). Rigid cardboard stiffeners are encased in a skin of flexible vinyl, which forms the hinges upon heat sealing. Alternatively, a fabric material such as canvas or even leather can be sewn over the cardboard stiffeners. Alternate stiffener materials such as corrugated plastic or honeycomb core material or even graphite fiber reinforced panels can be used to enhance the stiffness-to-weight ratio. Alternate construction involves the use of monolithic panels of a wide variety of materials, which are attached together using high strength fabric tapes with aggressive adhesive thereby forming the necessary hinges. These panels can be made of titanium, magnesium or aluminum alloys, or rigid plastic panels such as closed-cell expanded high density PVC sheet.

The illumination is provided either by a pair of light emitting diodes (LED's) or by an electroluminescent (EL) panel. These compact low-height light sources are attached to the inside of the top panel of the shield. Ideally they are powered by the Universal Serial Bus (USB) or IEEE 1394 (Firewire) ports of the portable computer. Alternatively, the light source can be powered by a lithium coin cell or equivalent. Another light source is the “SMARTLYTE™” of Acolyte Systems, Inc. of New York, N.Y.

In a preferred embodiment of this invention, the shield includes a left snap panel with a pair of male snaps (instead of a single snap) while a right snap panel also has a pair of male snaps. When assembled, these male snaps connect to respective female snaps. When fully closed, these pairs of snaps will mate on the top panel of the shade shield.

An optional light pocket includes a round hole to permit access to a pushbutton switch for operating a removable light module.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a Flat bottom plan view showings all panels and hinged joints of the shield of this invention;

FIG. 2 is a right isometric view of assembled shield prior to installation on a portable laptop computer;

FIG. 3 is a Left isometric view of shield installed on a portable laptop computer;

FIG. 4 is a Bottom plan view of the folded shield;

FIG. 5 is a Detail of a bottom of the top panel with a battery powered light system installed;

FIG. 6 is a Detail of the bottom of the top panel with an EL light panel system installed;

FIG. 7 is a Circuit diagram of a two LED lighting system;

FIG. 8 is a Flat bottom plan view of a preferred embodiment of the shield of this invention;

FIG. 9 is a Perspective inside view of the closed shield;

FIG. 10 is a Perspective top view of the closed shield;

FIG. 11 is a Perspective top view of the closed shield with snap panels open at 90 degrees;

FIG. 12 is a Perspective top view of the closed shield with snap panels flat open;

FIG. 13 is a Perspective inside view of the closed shield with snap panels flat open;

FIG. 14 is a Perspective inside view of the closed shield with a back panel opened to about 90 degrees;

FIG. 15 is a Perspective inside view of the partially assembled shield with side panels at about 90 degrees to the top panel;

FIG. 16 is a Perspective inside view of the shield with snap panels snapped into side panels;

FIG. 17 is a Perspective inside view of the assembled shield with narrow bracket panels folded inward;

FIG. 18 is a Front perspective view of the assembled shield positioned to be mounted on a laptop computer;

FIG. 19 is a Side perspective view of the assembled shield positioned to be mounted on a laptop computer;

FIG. 20 is a Front perspective view of the shield mounted on a laptop computer;

FIG. 21 is a Side elevation view of an optional self-contained light module;

FIG. 22 is a Perspective view showing the top of the light module; and,

FIG. 23 is a Bottom plan view of the light module.

### DETAILED DESCRIPTION OF THE INVENTION

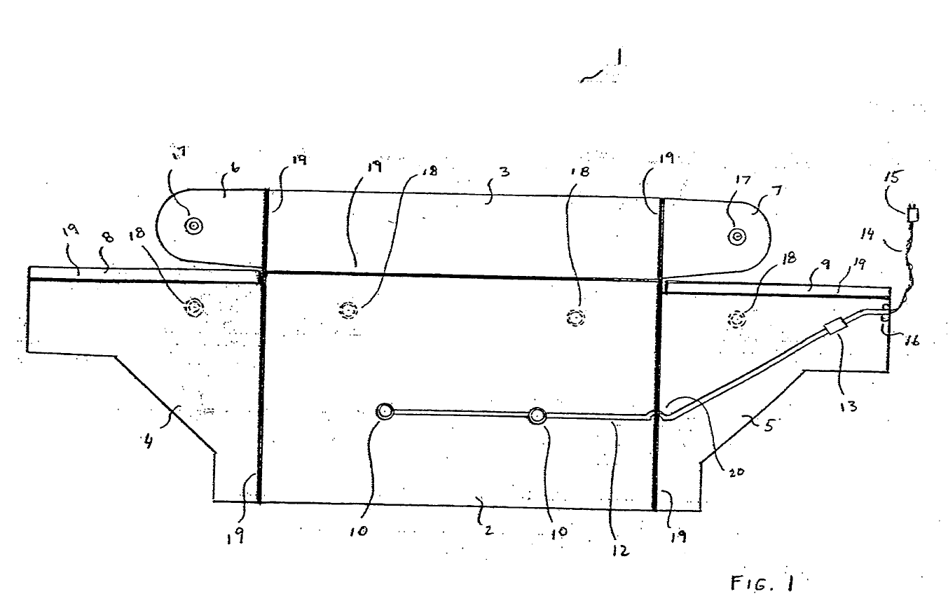

FIG. 1 shows shield 1 with all panels flattened out as on a table surface. It includes of top panel 2, left panel 4, right panel 5, back panel 3, left and right channel panels 8 and 9 respectively, and left and right snap panels 6 and 7 respectively. All panels are attached to one or more other panels using hinge members 19. Depending on construction, hinge members 19 can be integral with a cladding material such as soft vinyl, fabric or leather. In construction which does not use stiffeners within a surface cladding layer, panels are attached with fabric tape from the underside which forms hinges 19. Male snaps 17 are attached to snap panels 6 and 7. In the open configuration they would snap into female snaps 18 attached to side panels 4 and 5. In the compact folded configuration, snaps 17 would couple with female snaps 18 which are attached to top panel 2. One or more lights, such as a pair of light emitting diodes (LED) 10, attached to the underside of top panel 2, are used for illumination. Light emitting diodes (LED) 10 are either white LED's or red. The red variety help preserve night vision. They are optionally powered by an enclosed power source such as a battery as in the SMARTLYTE™ of Acolyte Systems, Inc.

In an alternate embodiment, light emitting diodes (LED) 10 are connected to a power source via a connection such as, for example flat ribbon cable 12, which is adhesively attached to the undersurface of panel 2 except for a short length 20 which facilitates bending at hinge 19. Resistors 13 are attached to side panel 5 (if required) and a cable strain relief 16 is also attached at the transition to dual conductor flexible cable extension 14 terminated in either USB or Firewire connector 15. Both of these computer interfaces can supply power to a small light. USB supplies 5 VDC at up to 500 ma. Approximately 15 to 30 ma would be required to power two LED's.

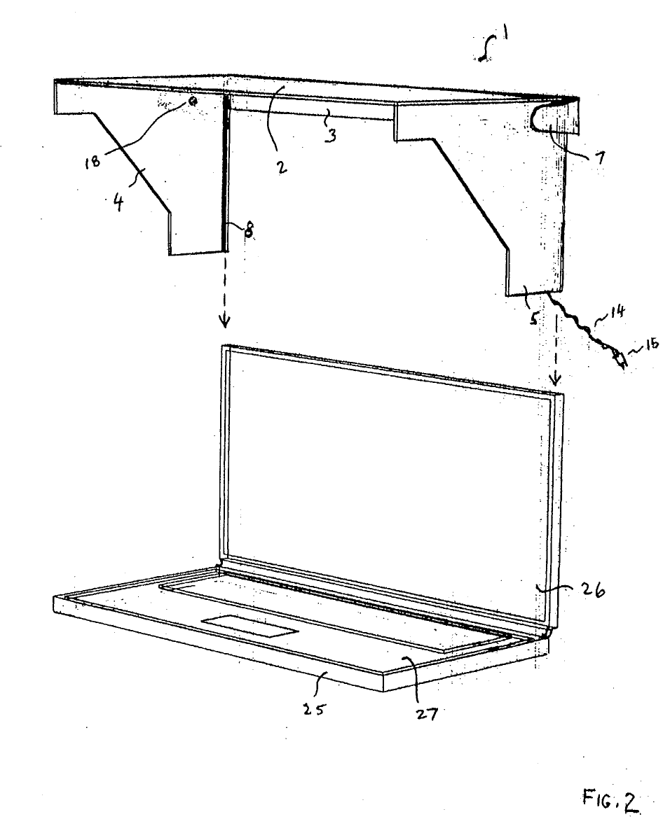

FIG. 2 shows an assembled shield 1 just prior to insertion over LCD screen panel 26 of notebook computer 25 with keyboard 27. Side panels 4 and 5 are mutually orthogonal to top panel 2 and back panel 3. Narrow channel panel 8 attached to side panel 4 is shown folded in (at approximately right angles). Snap panel 7 is shown snapped into side panel 5.

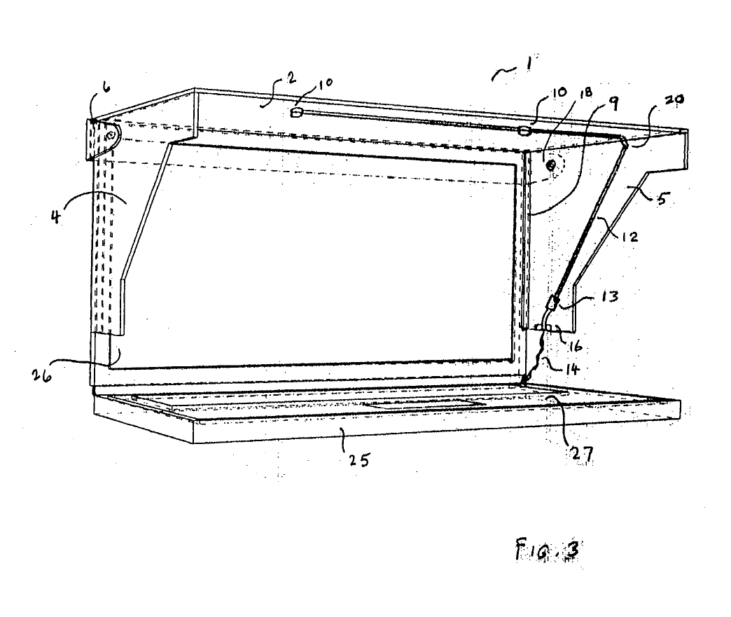

FIG. 3 shows shield 1 installed on computer 25. Narrow channel panel 9 rests against the front surface of the LCD screen 26 frame to prevent shield 1 from falling forward; it creates a counter moment to prevent this. Back panel 3 also bears on the backside of LCD screen 26 to aid in locating shield 1.

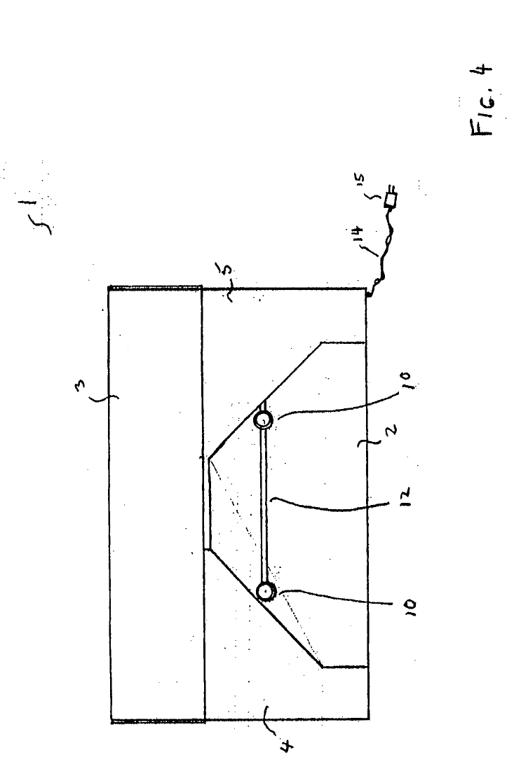

FIG. 4 is an underside view of folded shield 1. It is secured in this configuration by snap panels 6 and 7 (not shown in this view) being folded over and snapped into female snaps 18 attached to the top surface of panel 2.

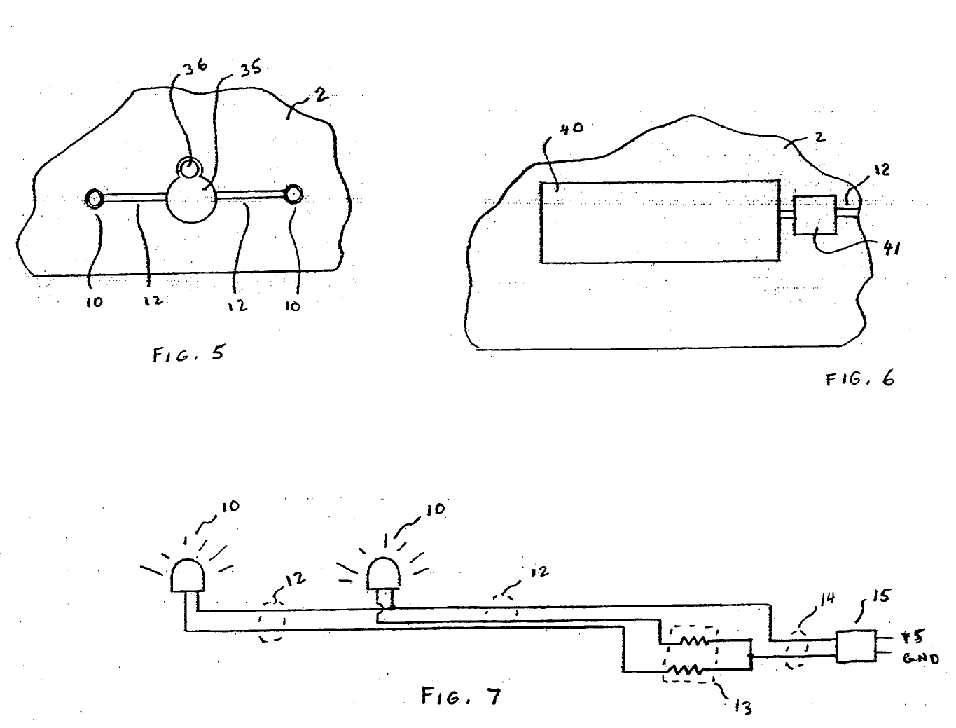

FIG. 5 is a detail showing the use of an alternate embodiment for a coin cell in housing 35 with push button switch 36 used to power LED's 10. These elements are attached to the underside of top panel 2. A Panasonic lithium P-187 coin cell can be used. This supplies 3 VDC with a capacity of 255 mAh. Such a cell can operate both LED's for over 10 hours; it only measures 23 mm in diameter and is 3 mm thick. Although FIG. 5 shows two light emitting diodes (LED) 10, it is known that a single light emitting diode may be used, or three or more light emitting diodes (LED) 10 may be used.

FIG. 6 shows a detail of the use of an alternate illuminative source such as EL panel 40 with driver circuit 41 attached to the underside of top panel 2 to supply illumination as a substitute for LED's 10. Standard driver circuit modules 41 invert the DC supply voltage into low current high-voltage high-frequency AC as required by EL panels. This type of light source is commonly used for backlighting LCD displays; it can be powered from the USB/Firewire outlet of a computer or alternatively by a small battery.

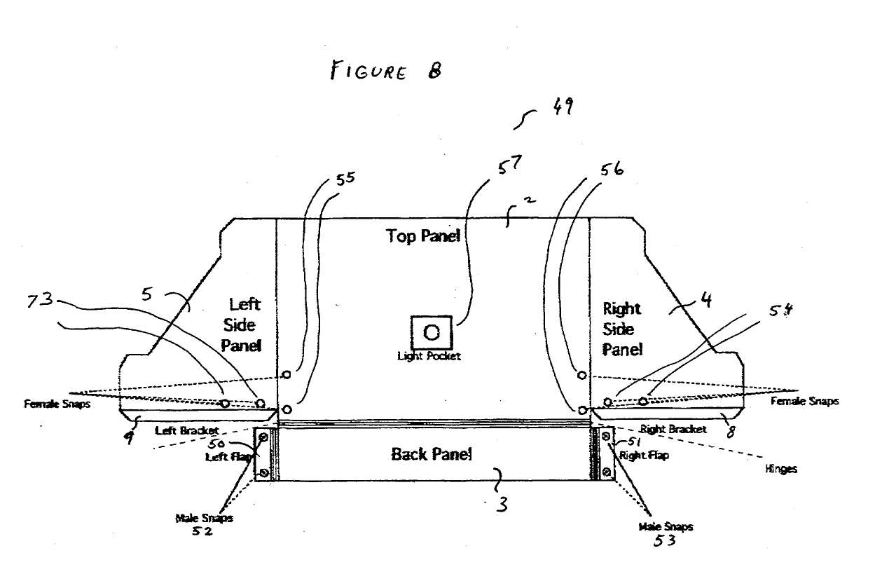

FIG. 7 shows the wiring diagram for two light emitting diodes (LED) 10 as wired in parallel to plug 15 with current limiting resistors 13 wired in series with each light emitting diode (LED) 10. Some types of light emitting diodes (LED) 10 contain their own dropping resistors internally to function with a 5 volt supply.

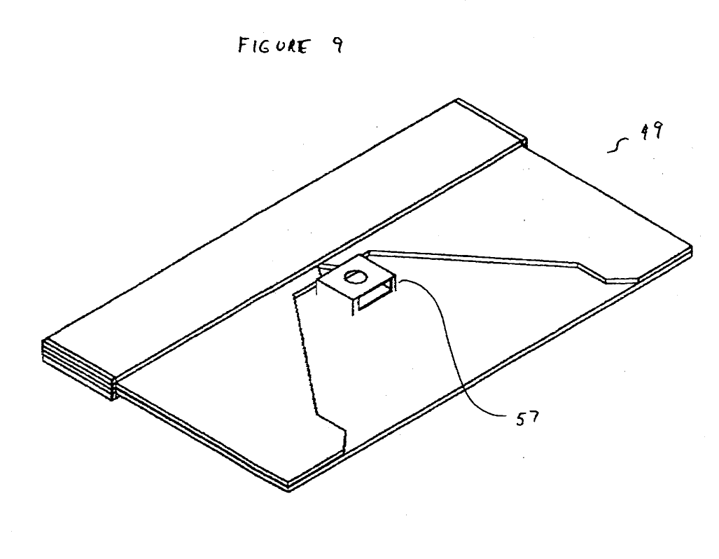

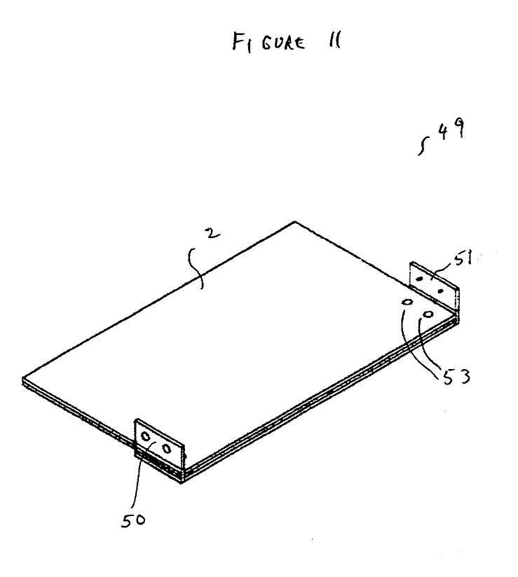

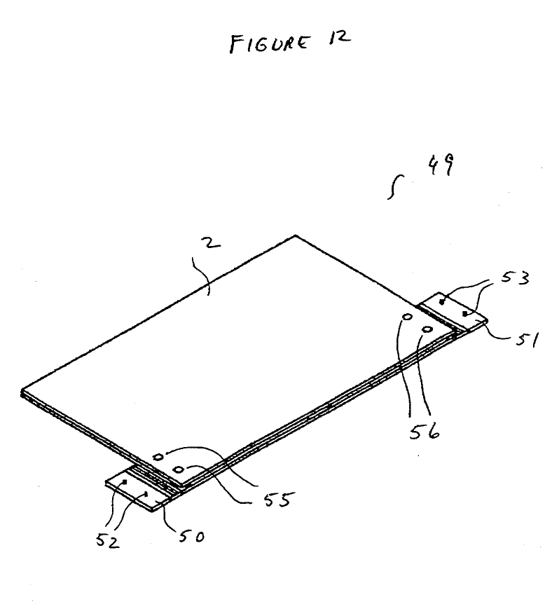

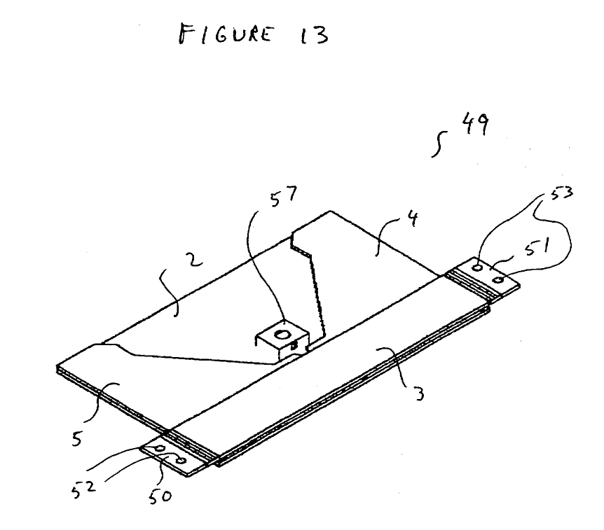

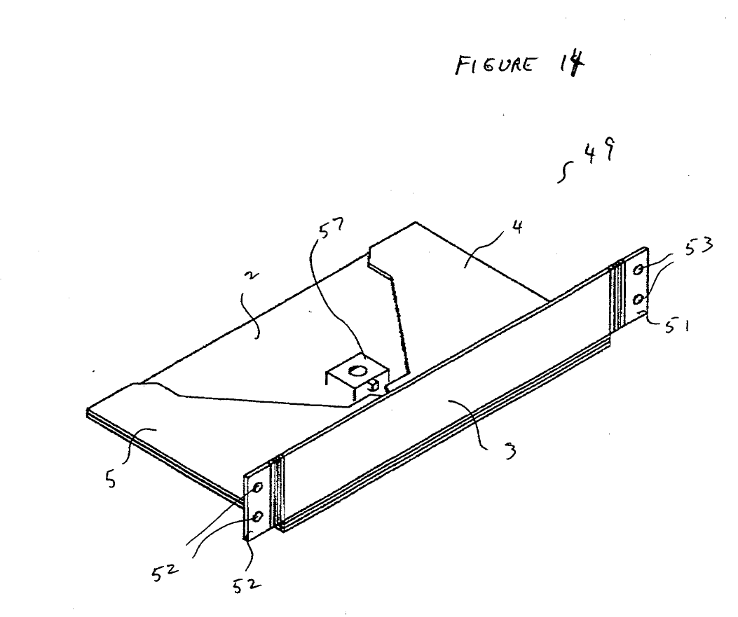

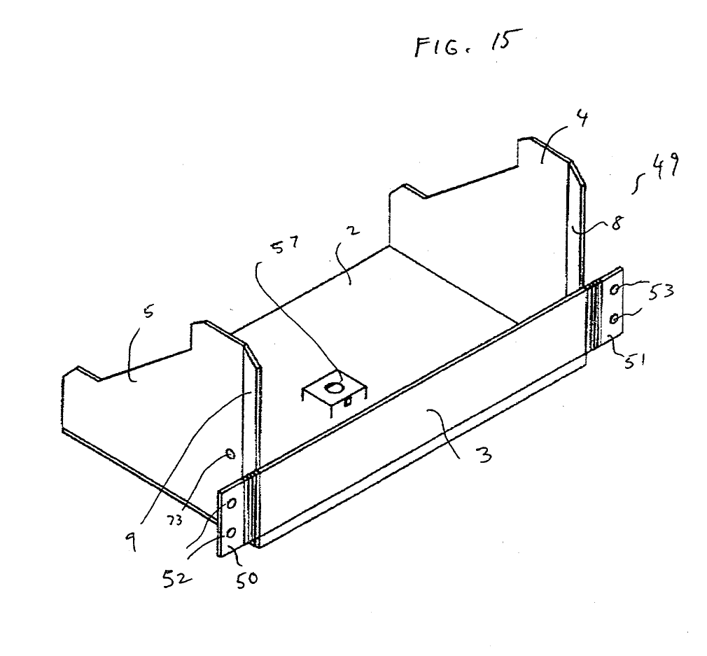

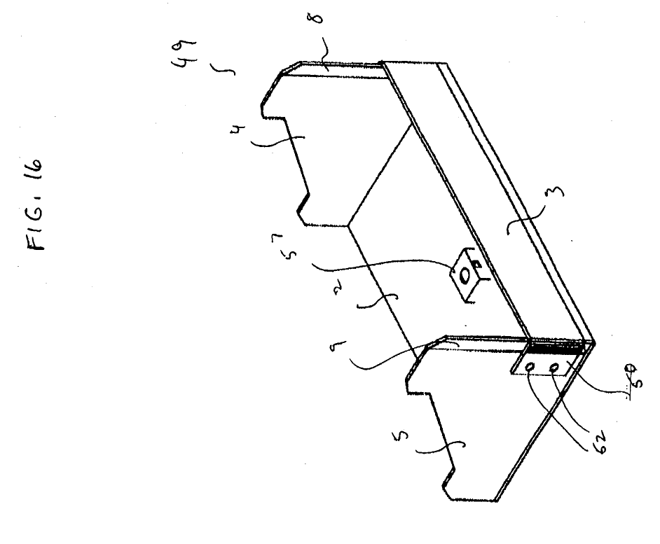

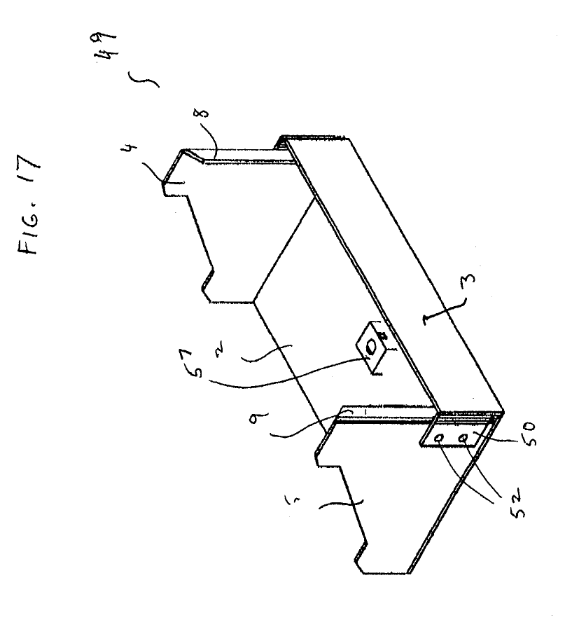

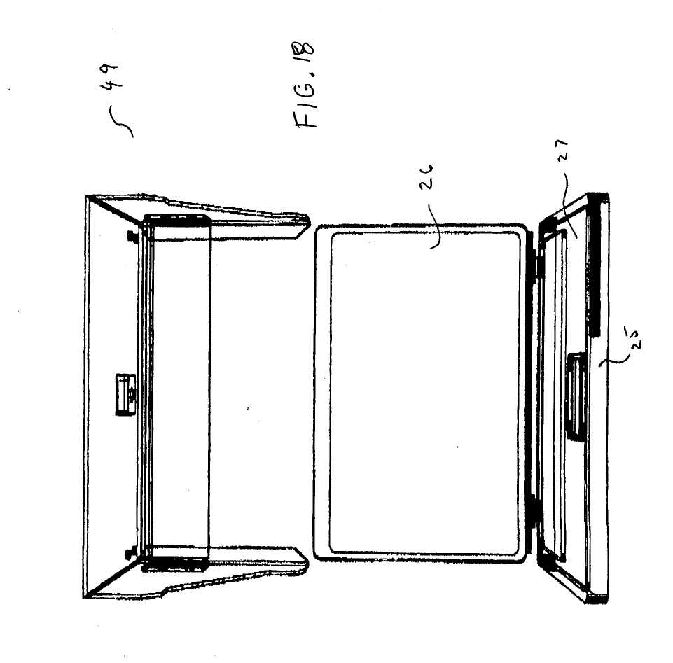

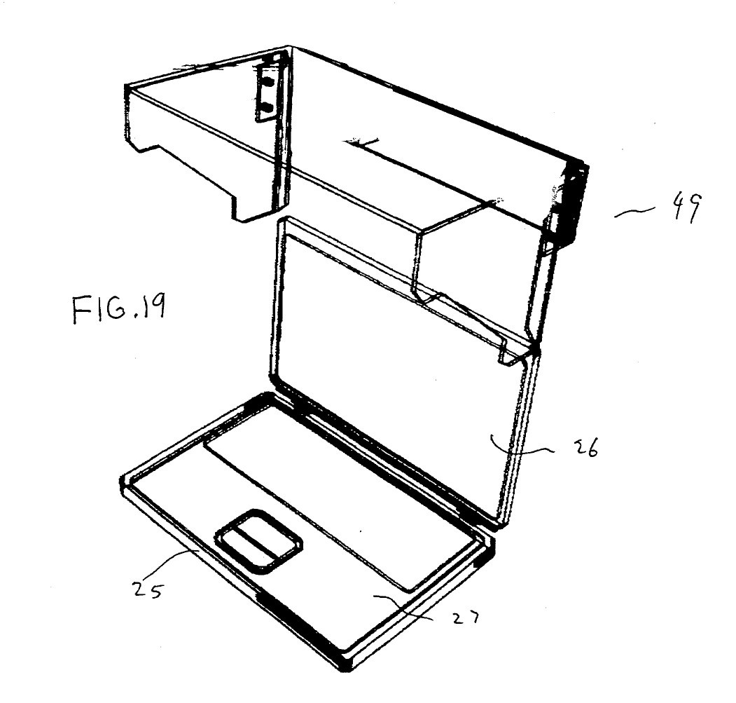

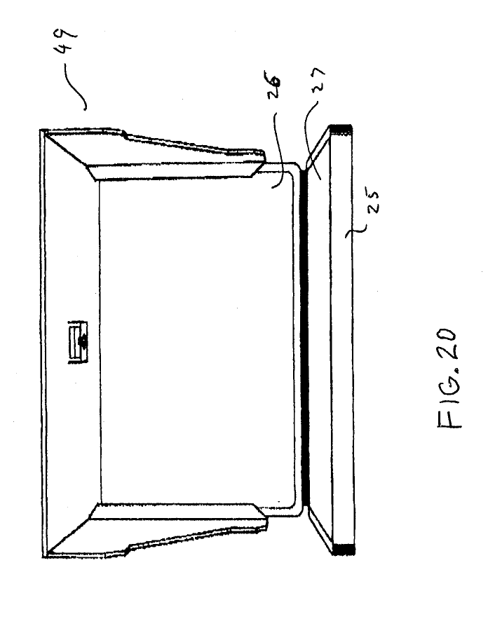

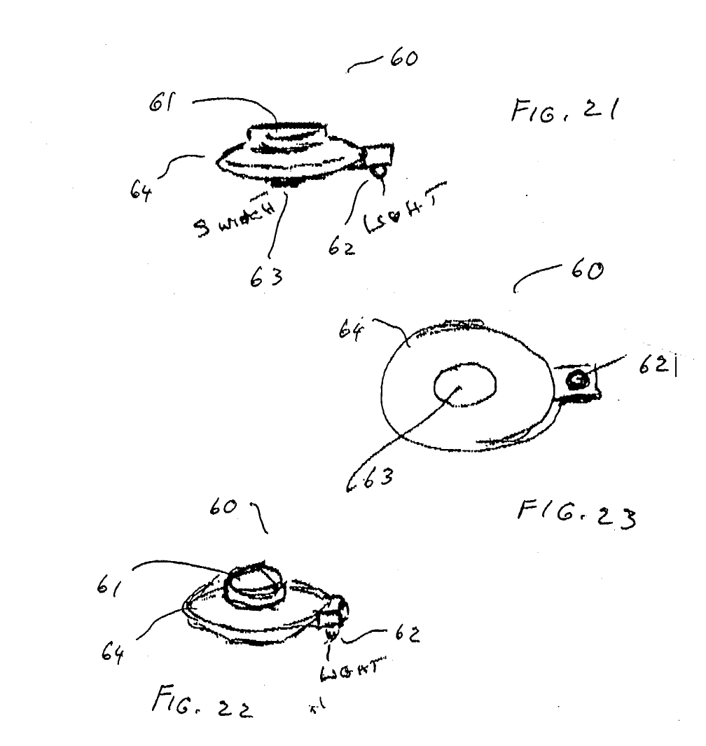

The series of FIGS. 8-23 show details of the preferred embodiment of this invention. Although it functions in a similar fashion to the shield described in FIGS. 1-8, some details are different.

FIG. 8 shows the differences clearly. Left snap panel 50 now has a pair of male snaps 52 (instead of a single snap) while right snap panel 51 also has a pair of male snaps 53. When assembled, snaps 52 will mate with female snaps 73 while snaps 53 will mate with female snaps 54. When fully closed, snap pair 52 will mate with female snaps 55 and snap pair 53 will mate with female snaps 56 on the top panel.

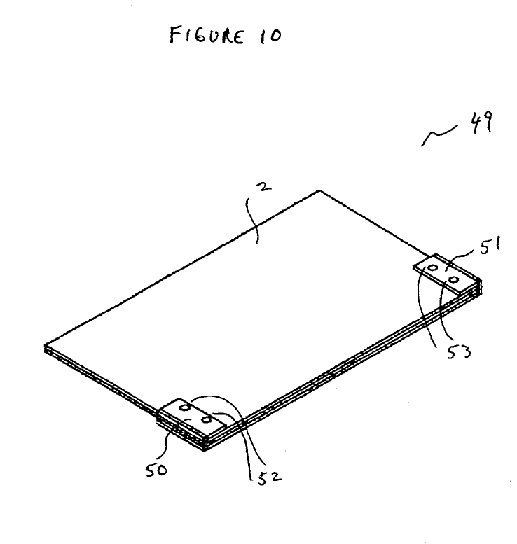

A light pocket 57 is clearly illustrated in FIGS. 8 and 9; it has a round hole to permit access to a pushbutton switch. This feature is a permanent part of the shield while light module 60 (see FIG. 21) is removable for servicing such as for changing batteries.

Light module 60 as illustrated in FIGS. 21-23 has housing 64, battery compartment 61, LED 62, and pushbutton switch 63. Light module 62 is slipped through the side opening of light pocket 57 with the actuator button of switch 63 accessible through the round hole.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended claims.

I claim:

1. A shade device for and in combination with a portable computer, comprising:
a top panel;
a back panel hinged to a rear edge of said top panel, said back panel having right and left foldable snap panels;
right and left side panels hinged to side edges of said top panel so that in the deployed position of said shade device said side panels are at right angles to said top panel and said right and left foldable snap panels fold over the outside of said right and left side panels to form a partial enclosure with said back panel at a right angle to said top panel;
right and left brackets hinged along edges of said side panels adjacent said back panel for engaging right and left sides of a screen panel of said portable computer, said back panel resting against a backside of said screen panel when said device is deployed on said screen panel; and
said shade device being collapsible by said side panels folding flat against said top panel and said back panel being folded onto said top panel over said side panels with said snap panels folded over the opposite side of said top panel.

2. The shade device of claim 1 in which said snap panels are each provided with at least one snap to engage a corresponding mating snap on each of said side panels when said shade device is deployed.

3. The shade device of claim 1 in which said snap panels are provided with a pair of snaps to engage a corresponding pair of mating snaps on said side panels when said shade device is deployed.

4. The shade device of claim 2 in which said top panel is provided with snaps for mating with said snaps on said snap panels when said shade device is collapsed.

5. The shade device of claim 1 further comprising at least one light being mounted in said top panel for providing light for said keyboard.

6. The shade device of claim 5 in which said light is energized through a connector in said portable computer.

7. The shade device of claim 6 in which said light is a light emitting diode (LED) light and the connector is a USB port.

8. The shade device of claim 6 in which said light is a light emitting diode (LED) light and the connector is a firewire port.

9. The shade device of claim 5 in which said light is energized by a lithium coin cell.

10. The shade device of claim 5 in which said light is an electroluminescent panel.

11. The shade device of claim 5 in which said light is a portable light insertable within a pocket in said top panel.

12. The shade device of claim 11 wherein said pocket has an access hole for accessing a switch on said portable light.

13. A shade device for and in combination with a portable computer, comprising:
a top panel having a light source mounted on an underside thereof;
a back panel hinged to a rear edge of said top panel, said back panel having right and left foldable snap panels;
right and left side panels hinged to side edges of said top panel so that in the deployed position of said shade device said side panels are at right angles to said top panel and said right and left foldable snap panels fold over the outside of said right and left side panels to form a partial enclosure with said back panel at right angles to said top panel, and said light source providing illumination for a screen panel and keyboard of said portable computer;
right and left brackets hinged along edges of said side panels adjacent said back panel for engaging right and left sides of said of a screen panel of said portable computer, said back panel resting against a backside of said screen panel when said device is deployed on said screen panel; and
said shade device being collapsible by said side panels folding flat against said top panel and said back panel being folded onto said top panel over said side panels with said snap panels folded over the opposite side of said top panel.

14. The shade device of claim 13 in which said side panels are shaped such that when folded flat against said top panel said light source remains uncovered.
